(19) United States
(12) Patent Application Publication
(10) Pub. No.: US 2014/0158601 A1
(43) Pub. Date: Jun. 12, 2014

(54) TRAVELING BAND SCREEN, ASSOCIATED ROLLER AND RELATED METHOD FOR RETROFITTING A TRAVELING BAND SCREEN ASSEMBLY

(71) Applicant: OVIVO LUXEMBOURG S.A.R.L., Munsbach (LU)

(72) Inventor: Sid Jones, Braintree (GB)

(73) Assignee: Ovivo Luxembourg S.a.r.l., Munsbach (LU)

(21) Appl. No.: 13/712,219

(22) Filed: Dec. 12, 2012

(51) Int. Cl. B01D 33/056

(52) U.S. Cl. CPC B01D 33/056
USPC 210/232; 210/401; 29/402.01

(57) ABSTRACT

A traveling band screen has a support frame assembly, two continuous chains movably mounted to the support frame assembly for motion along respective mutually parallel endless paths, a plurality of mesh members each secured on opposing edges to the chains, and a plurality of rollers rotatably mounted to each of the chains. One or more of the rollers are split rollers. Each such split roller has a respective rotation axis extending perpendicularly to the respective chain and accordingly to the path of motion of the chin. Each split roller has two roller halves secured to one another via elongate fasteners that extend parallel to the respective roller rotation axis.

### BACKGROUND OF THE INVENTION

The present invention relates to water intake screens, particularly traveling belt or band screens, as used in a wide range of municipal, industrial, institutional, and intake flows for removing debris from flowing water.

In municipal wastewater treatment, band or belt screens are more particularly deployed in wastewater treatment plant headworks, wastewater sludge screening and thickening, pump stations, and algae removal. In industrial wastewater treatment, band or belt screens are utilized in the pulp and paper industry, the textile industry, in chemical processing plants, in meat and poultry processing facilities, in mining operations, and in manufacturing. In heavy industrial processes such as power generation, band or belt screens are more particularly deployed in cooling tower scale removal, raw water intake for potable water purposes, irrigation system protection, and fish farming.

The first step in wastewater treatment is normally the removal of solids from the wastewater flow by means of screens, particularly including traveling band or belt screens. The removed screenings contain household waste, fecal matter, toilet paper and mineral solids. The screenings volume depends, not only on the separation size of the screen, but also on the type of sewer system.

A traveling band- or belt-type water intake screen apparatus has elements that form a continuous or endless band that is disposed in a frame or support generally transversely to a moving aqueous stream, for purposes of removing debris from the stream. Typically, such a water intake screen apparatus comprises a series of planar sieves or grid members that are attached at their lateral edges to a pair of parallel endless chains that are driven in an oval or endless path over multiple sprockets. Flow passes through the screen and is constantly presented a clean grid surface, while solids are transported to an apex of screen movement. Water passes through sieve elements and may exit at the sides of the apparatus. As captured or entrained debris travels up and over top of the belt or band, the debris is discharged into a container, conveyor, screenings washer, or compactor. At the discharge point, the debris may be removed by water sprays or jets. Wet or dry removal provides the option to effectively clean screen and discharge wastes appropriate for disposal.

Traveling band screens may be installed in an intake screening system downstream from trash rakes or coarse bar screens and upstream of a circulating water pump. The principal function of the traveling band screens is to remove debris (from 1 mm-10 mm) before the circulating water is distributed to sensitive plant components. When water flows through the panels of the traveling water screen, debris is collected on the mesh or sieve panels. As the screen rotates, the debris is carried up to a deck level where a pressure spray flushes it from the panels into a debris trough. The clean panels then rotate back into a water reservoir, resulting in continuous, uninterrupted screening.

### OBJECTS OF THE INVENTION

It is an object of the present invention to provide an improved traveling band screen

Another object of the present invention is to provide a traveling band screen with improved rollers.

A particular object of the present invention is to provide a traveling band screen with rollers that facilitate replacement of damaged or worn rollers.

A more particular object of the present invention is to provide a traveling band screen with replacement rollers that reduce screen downtime owing to roller maintenance and repair operations.

A related object of the present invention is to provide a traveling band screen with replacement rollers that may be installed with greater ease and less expense than conventional methods of roller replacement.

These and other objects of the invention will be apparent from the drawings and descriptions herein. Although each of the objects of the invention is believed to be attained in at least one embodiment of the invention, there is not necessarily any one embodiment that achieves all of the objects of the invention.

### SUMMARY OF THE INVENTION

A traveling band screen in accordance with the present invention comprises a support frame assembly, two continuous chains movably mounted to the support frame assembly for motion along respective mutually parallel endless paths, a plurality of mesh members each secured on opposing edges to the chains, and a plurality of rollers rotatably mounted to each of the chains. One or more of the rollers are split rollers. Each such split roller has a respective rotation axis extending perpendicularly to the respective chain and accordingly to the path of motion of the chain. Each split roller has two roller halves secured to one another via elongate fasteners that extend parallel to the respective roller rotation axis.

Pursuant to another feature of the present invention, each split roller half includes a main body in the form of an annular section and further includes two tongues or flanges. One tongue or flange is formed on one end of the annular section and the other tongue or flange is formed on an opposite end of the annular section. The tongues or flanges of one roller half engage respective tongues or flanges of the other roller half so that the tongues or flanges on each side of the split roller overlap and are at least substantially coextensive with one another. The elongate fastener elements extend at least partially into each of the tongues or flanges.

Pursuant to a further feature of the present invention, each of the tongues or flanges of a given split roller half has formations that interdigitate or mate with corresponding formations on an overlapping tongue or flange of the other split roller half.

More particularly, where each tongue or flange of one roller half has a face that is engageable with a surface of a tongue or flange of the other roller half, the face of the one roller half has a first raised area and a first recessed area, while the surface of the second roller half has a second raised area and a second recessed area. The first raised area extends into the second recessed area and the first recessed area receives the second raised area.

Each split roller half has a partially semi-annular body section of a predetermined thickness, the tongues being formed at each of two opposite ends of the body section. Each of the flanges or tongues is of approximately half the predetermined thickness of the main body section. The raised areas of the tongues or flanges are preferably formed at the free ends of the tongues or flanges. The recessed areas are formed adjacent the main body section.

The split rollers have an overall flattened form so that they are more ring-shaped than cylinder-shaped. Thus each split roller can be said to be a planar element, with the elongate fasteners extending perpendicularly to the plane of the roller.

The present invention is also directed in part to a method for repairing or maintaining a traveling band screen. Such a screen includes a supporting frame assembly, a pair of continuous chains, and a multiplicity of mesh or sieve members. Each of the chains carries a plurality of rollers that engage the supporting frame assembly for enabling motion of the chains along respective mutually parallel endless paths. The mesh or sieve members are each secured along opposing edges to respective ones of the chains. Each of the rollers is turnably mounted on a rotation shaft in turn mounted to one of the chains. The method of the present invention, for repairing or maintaining such a traveling band screen, comprises (i) removing a selected one of the rollers, (ii) maintaining the respective chain in a continuous and operative configuration and maintaining the respective rotation shaft connected to the respective chain during the removing of the selected roller, (iii) subsequently mounting a new roller to the respective rotation shaft, and (iv) maintaining the respective chain in a continuous and operative configuration and maintaining the respective rotation shaft connected to the respective chain during the mounting of the new roller. Thus the present invention enables one to replace a selected roller without disassembling or disassociating any links of the respective chain and without removing the respective rotation shaft.

According to an aspect of the present invention, the new roller is a split roller comprising a pair of roller halves. The mounting of the new roller to the respective rotation shaft then includes inserting the roller halves about the respective rotation shaft and fixing the roller halves to one another by inserting a pair of elongate fastener elements at least partially through the roller halves parallel to the respective rotation shaft.

Each roller half may include a main body in the form of an annular section and further include two tongues or flanges, one of the tongues or flanges being formed on one end of the annular section and the other of the tongues or flanges being formed on an opposite end of the annular section. Then the mounting of the new roller to the respective rotation shaft includes placing the tongues or flanges of one roller half into engagement with respective tongues or flanges of the other roller half so that the tongues or flanges on each side of the assembled new roller overlap and are at least substantially coextensive with one another. The inserting of the elongate fastener elements at least partially through the roller halves includes inserting the fastener elements into the tongues or flanges.

The tongues or flanges may have recessed and raised areas which mate upon an assembly of the roller halves. The method then includes aligning the recesses and raised areas with one another and inserting the raised areas into the recesses. Each of the tongues or flanges of one roller half has a face that is engageable a surface of a tongue or flange of the other roller half, the face having a first raised area and a first recessed area, the surface having a second raised area and a second recessed area, the mounting of the new roller to the respective rotation shaft including inserting the first raised area into the second recessed area and inserting the second raised area into the first recessed area.

According to another feature of the present invention, the mounting of the new roller to the respective rotation shaft includes supporting a first roller half on a holder tool below the respective rotation shaft, maneuvering a second roller half over the respective rotation shaft and onto the first roller half on the holder tool to form a partially assembled configuration of the new roller, and supporting the partially assembly configuration on the holder tool during the inserting of the elongate fastener elements into the roller halves parallel to the respective rotation shaft.

The present invention is directed in part to a split roller specifically designed for a traveling band screen that includes a supporting frame assembly, a pair of continuous chains, a multiplicity of mesh or sieve members, and a plurality of rollers on each chain. The rollers engage the supporting frame assembly for enabling motion of the chains along respective mutually parallel endless paths. Each mesh or sieve member is secured along opposing edges to respective ones of the chains. Each of the rollers is rotatably mounted on a respective rotation shaft mounted to the respective chain. The split roller that is carried on one of the chains comprises a pair of roller halves and a pair of elongate fastener elements. The elongate fastener elements extend at least partially through the roller halves parallel to an axis of rotation of the split roller.

As discussed above, each roller half includes a main body in the form of an annular section and further includes two tongues or flanges, one such tongue or flange being formed on one end of the annular section and the other tongue or flange being formed on an opposite end of the annular section. The tongues or flanges of one roller half engaging respective tongues or flanges of the other roller half so that the tongues or flanges on each side of the split roller overlap one another and are at least substantially coextensive with one another. The elongate fastener elements extend at least partially into the tongues or flanges.

A tongue or flange of one roller half has a face that is engageable with a surface of a tongue or flange of the other roller half. The face and surface each have a raised area and a recessed area. The raised area of either tongue or flange fits into the recessed area of the other tongue or flange, resulting in an interlocking of the roller halves to one another.

In a traveling band screen in accordance with the present invention, maintenance and repair operations are facilitated and downtime is reduced, thereby reducing costs and enabling more continuity in production. Damaged rollers may be removed and new rollers installed without removing the chains. Typically, chain removal in conventional repair of damaged or worn rollers results in chain damage and the consequent necessity of replacing part or all of a respective chain. This means an increase in downtime and a significant increase in costs as chains can be very expensive.

The new split rollers in accordance with the present invention aid replacement and can be replaced without the need to remove the chain or mesh panels which form the continuous belt which previously had to be removed in order to replace any broken or damaged rollers. This in turn reduces the amount of chain which is damaged due to the unswaging and swaging of the chain, during the replacement process. Typically the amount of chain damaged is 25% of the total chain per screen. By not having to remove or replace either the chain or the mesh panels, the amount of downtime is reduced from typically two to three days (if a complete belt has all the rollers replaced) to a maximum of 1 day. This saving in downtime and production savings is very difficult to cost, as it will have a greater or lesser saving, dependent on the country labor costs, but in the USA, the labor cost would be in the region of $50/hour/man (typically the replacement of rollers would be a three person operation).

### BRIEF DESCRIPTION OF THE DRAWINGS

FIG. 1 is a schematic front elevational view of a traveling band screen assembly in accordance with the present invention.

FIG. 2 is a partial front elevational view, on a much larger scale, of the traveling band screen assembly of FIG. 1.

FIG. 3 is a detail view, on an even larger scale, of a portion III of FIG. 2, depicting a split roller substituted for a conventional roller shown in FIG. 2.

FIG. 4 is a front elevational view of a split roller included in the traveling band screen assembly of FIGS. 1-3.

FIG. 5 is a top plan view of the split roller of FIG. 4

FIG. 6 is a cross-sectional view taken along line VI-VI in FIG. 4.

FIG. 7 is an exploded perspective view of the split roller of FIGS. 4-6., showing two cooperating roller halves.

FIG. 8 is a side elevational view of one of the roller halves of FIG. 7.

FIG. 9 is a schematic front elevational view of a split roller as in FIGS. 4-8 and a clamping tool for assisting in the assembly of the split roller to an endless chain of the traveling band screen of FIGS. 1-3.

FIG. 10 is a perspective or isometric view of a modified clamping tool for use in installing the split roller of FIGS. 4-8 to an endless chain of the traveling band screen of FIGS. 1-3.

FIG. 11 is a side elevational view of the clamping tool of FIG. 10.

FIG. 12 is a cross-sectional view taken along line XII-XII in FIG. 11.

FIG. 13 is a front elevational view of the clamping toll of FIGS. 10-12.

### DETAILED DESCRIPTION

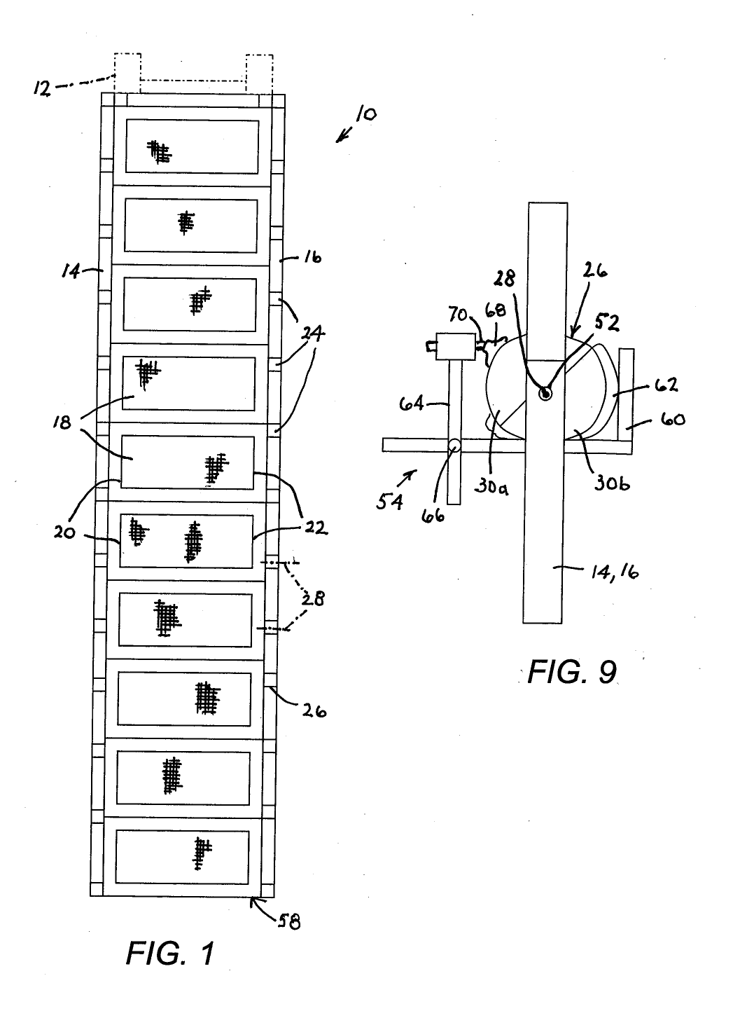

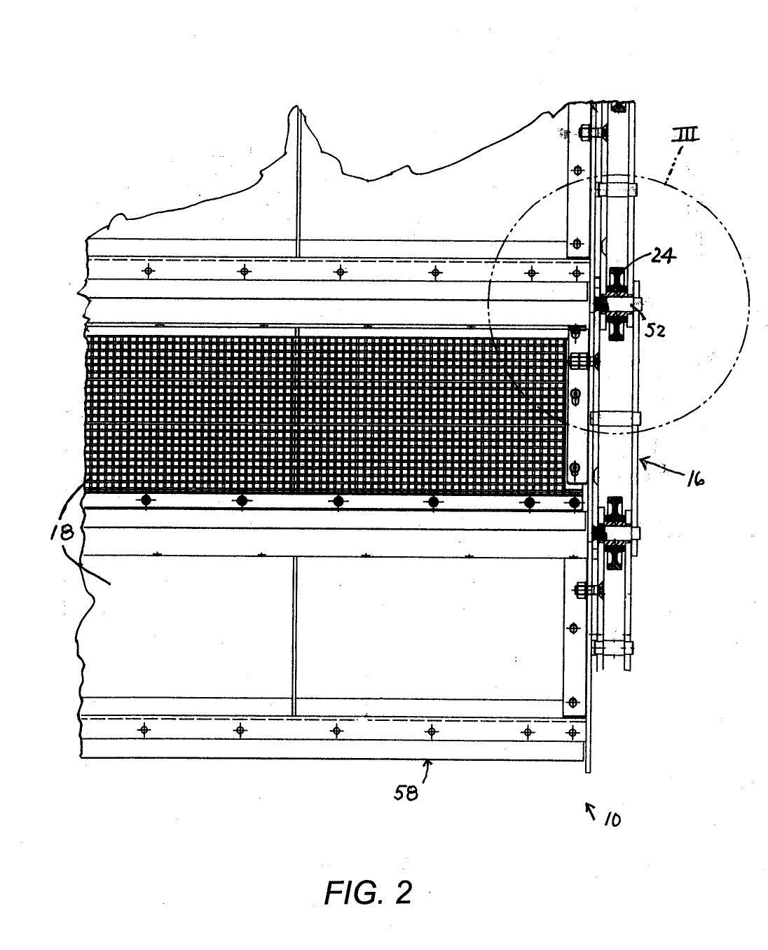

As depicted in FIGS. 1 and 2, a traveling band screen 10 comprises a support frame assembly 12 to which two continuous chains 14 and 16 are movably mounted for motion along respective mutually parallel endless paths. A plurality of mesh or sieve members 18 are each secured along opposing edges 20 and 22 to chains 14 and 16. Each chain 14 and 16 carries a plurality of rotatable rollers 24. One or more of the rollers 24 are split rollers 26. Each such split roller 26 has a respective rotation axis 28 extending perpendicularly to the respective chain 14 or 16 and accordingly to the path of motion of the chain. As discussed in detail hereinafter with reference to FIGS. 4-8, each split roller 26 has two roller halves 30a and 30b secured to one another principally via elongate fasteners 32 and 34 that extend parallel to the respective roller rotation axis 28. Fasteners 32 and 34 may take any suitable form, including screws, bolts or rivets.

Each split roller half 30a and 30b includes a main body 36a and 36b in the form of an annular section that is somewhat less than semi-annular. In addition, split roller half 30a includes two connector tongues or flanges 38a and 40a that extend from opposite ends of annular body section 36a, while split roller half 30b includes two connector tongues or flanges 38b and 40b that extend from opposite ends of annular body section 36b.

Split roller 26 has a flattened cylindrical configuration and is therefore more in the form a ring than a cylinder. Each partially semi-annular body section 36a and 36b is of a predetermined thickness t (FIGS. 5 and 6). Connector tongues 38a, 40a and 38b, 40b each have a thickness (not separately designated) that is approximately one-half that of main body thickness t. Accordingly, each split roller can be said to be a planar element located in a plane defined by the path of motion of the respective chain 14 or 16. Fasteners 32 and 34 extend perpendicularly to the plane of the split roller 26.

In the assembled configuration of split roller 26 (FIGS. 4-6), tongues or flanges 38a, 40a of roller half 30a overlap, and are coextensive with, respective tongues or flanges 38b, 40b of roller half 30b. As shown in FIGS. 6 and 7, elongate fastener element 32 extends through a bore 39b in tongue 38b and partially into a bore or aperture 39a in tongue 38a, while fastener 34 extends through a bore 41a in tongue 40a and partially into a bore 41b in tongue 40b.

The tongues or flanges 38a, 40a, and 38b, 40b of split roller halves 30a and 30b have formations 42a and 42b that interdigitate or mate with one another, as shown particularly in FIG. 5. Specifically, tongue or flange 38a of roller half 30a is provided on a surface (not separately designated) facing tongue or flange 38b of roller half 30b with a recessed area 44a and a raised area 46a. Similarly, tongue or flange 38b of roller half 30b is provided on a surface (not separately designated) facing tongue or flange 38a of roller half 30a with a recessed area 44b and a raised area 46b. In the assembled configuration of split roller 26 (see FIGS. 4 and 5), the raised areas 46a and 46b are matingly received in the recessed areas 44b and 44a, respectively.

The same locking or interdigitation exists between tongues or flanges 40a and 40b. Specifically, tongue or flange 40a of roller half 30a is provided on a surface (not separately designated) facing tongue or flange 40b of roller half 30b with a recessed area 48a and a raised area 50a. Similarly, tongue or flange 40b of roller half 30b is provided on a surface (not separately designated) facing tongue or flange 40a of roller half 30a with a recessed area 48b and a raised area 50b. In the assembled configuration of split roller 26, the raised areas 50a and 50b are nested in the recessed areas 48b and 48a, respectively.

Raised areas 46a and 46b are formed at the free ends of tongues or flanges 38a and 38b, respectively. Concomitantly, recessed areas 44a and 44b are located adjacent main body sections 36a and 36b of the roller halves 30a and 30b. The same disposition is found in the formations 42a, 42b of tongues or flanges 40a and 40b. Specifically, raised areas 50a and 50b are formed at the free ends of tongues or flanges 40a and 40b, respectively, while recessed areas 46a and 46b are located adjacent main body sections 36a and 36b of split roller halves 30a and 30b.

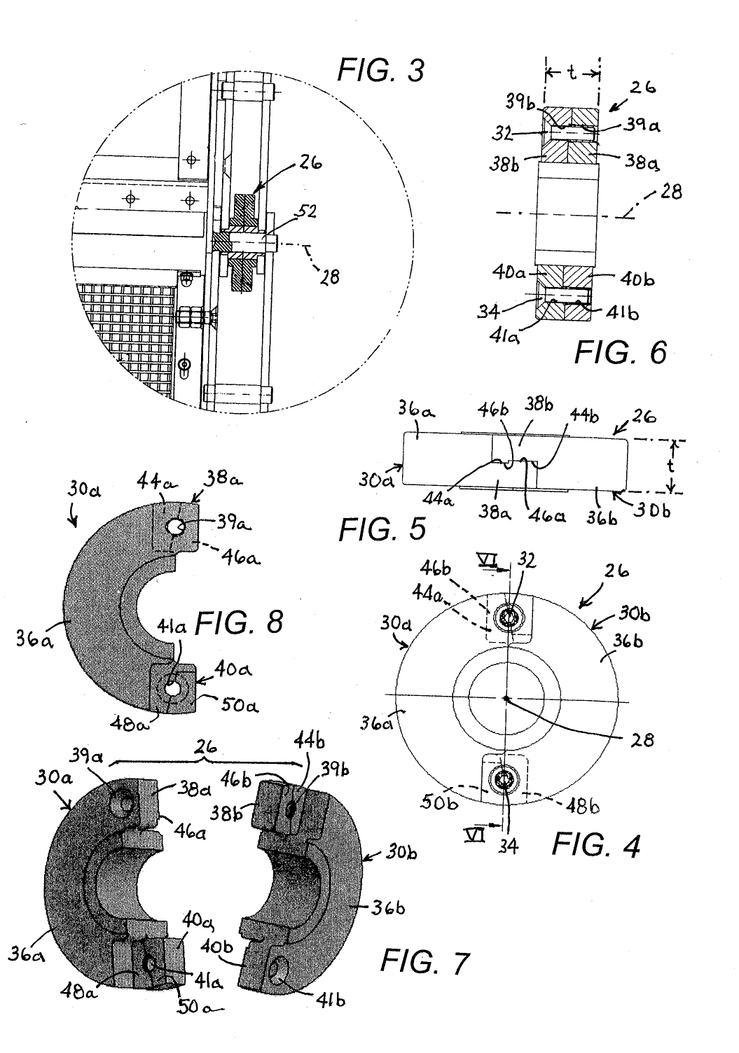

In a method for repairing or maintaining traveling band screen 10, particularly replacing a damaged or worn roller 24 or 26, one removes the roller while maintaining the respective chain 14, 16 in a continuous and operative configuration and maintaining a respective roller rotation shaft 52 (FIGS. 2 and 3) connected to the respective chain 14, 16 during the removing of the selected roller 24. One subsequently mounting a split roller 26 to respective rotation shaft 52, again while maintaining the respective chain 14, 16 in a continuous and operative configuration and maintaining the respective rotation shaft 52 connected to the respective chain 14, 16 during the mounting of the new roller 26. One is thereby able to replace a selected roller 24 or 26 without disassembling or disassociating any links of the respective chain 14, 16 and without removing the respective rotation shaft 52.

To replace a conventional non-split roller 24 one may use a reciprocating saw (not shown), a torque wrench (not shown), a roller assembly tool 54 or 56 (FIGS. 9-13), and common hand tools. First, one ensures that the band screen chamber is drained and isolated. The screen band 58, including chains 14 and 16 and mesh members 18, is rotated under power to a position that facilitates access to the worn or damaged roller 24. Top covers (not shown) are removed to facilitate access to the band screen apparatus 10. To remove the target roller 24 from the assembly, one uses the reciprocating saw to cut the roller almost completely through in two positions opposite one another. The roller 24 is then split into halves, using the cut areas as break points. It is advisable to shut the Penstock to prevent any broken roller halves that may fall into the liquid chamber from being drawn into the main intake. It is also advisable to check channels on both sides of each mesh or sieve element for broken roller pieces once the installation for total screen assembly is complete.

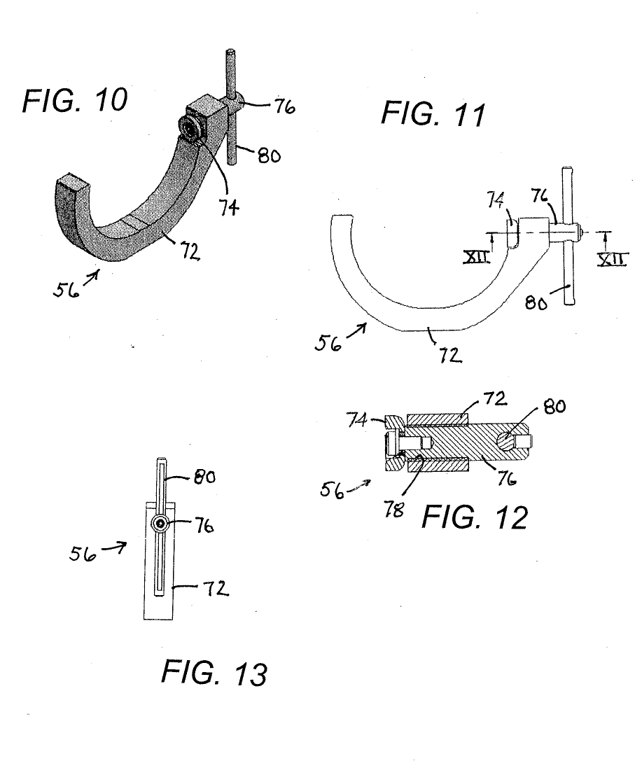

One may use a special clamping tool 54 of FIG. 9 or clamping tool 56 of FIGS. 10-13 to hold and assemble split roller 26. One locates and properly aligns two roller halves 30a and 3b in clamping tool 54 or 56 and then pulls the roller halves 30a and 30b together, ensuring that no gaps or steps are between the roller halves when they are fully locked in position.

Clamping tool 54 includes an L-shaped bracket 60 and a cylindrically arcuate seat member 62 that is welded to the bracket and seats one of the split roller halves 30b. Clamping tool 54 further includes a slidable bracket member 64 that includes a set screw 66 and is movably mounted to bracket 60. A clamping head 68 is pivotably secured to a pin 70 in turn mounted to bracket member 64. Clamping head 68 engages the other split roller half 30a so that the clamping tool 54 holds the two roller halves 30a and 30b firmly together.

Clamping tool 56 is more in the form of a C clamp, with a C-shaped body member 72 and a clamping head 74 pivotably attached to an end of a threaded shifting rod 76 that traverses a threaded bore 78 in one end of the C-shaped body member 72. A handle 80 providing in one end of shifting rod 76 facilitates adjustment and tightening of clamping head 74.

It is to be noted that each split roller 26 is preferably machined and split as a single unit. Roller halves 30a, 30b must remain as matching pairs when installed on chain 14 or 16 to optimize roller integrity and strength. To further ensure roller integrity and strength upon assembly, it is necessary to use an adhesive, for instance, a dimethylacrylate ester such as Loctite™ which cures in the absence of air between close fitting metal surfaces to prevent loosening and leakage from shock and vibration. After all worn and damaged rollers 24, 26 have been replaced with respective split rollers 26, the traveling band screen 10 is operated to check movement and seals. Seals are adjusted as necessary.

The installation of new roller 26 on the respective rotation shaft 52 includes inserting the roller halves 30a, 30b about that rotation shaft and fixing the roller halves to one another by inserting fastener elements 32 and 34 at least partially through the roller halves 30a, 30b parallel to the respective rotation shaft 52. The mounting of new roller 26 to rotation shaft 52 more specifically includes placing tongues or flanges 38a and 40a of one roller half 30a into engagement with respective tongues or flanges 38b and 40b of the other roller half 30b so that the tongues or flanges 38a and 38b on the one side of the assembled new roller 26, as well as the tongues or flanges 40a and 40b on the other side of the new roller, overlap one another and are at least substantially coextensive. Elongate fastener elements 32 and 34 are inserted into the tongues or flanges 38a, 38b and 40a, 40b.

The installing of split roller 26 on chain 14 or 16 includes aligning recesses 44a, 44b and 48a, 48b with respective raised areas 46b, 46a and 50b, 50a and inserting the raised areas into the recesses.

Roller half 30b is disposed on holder tool 54 or 56 below the respective rotation shaft 52. Roller half 30a is then maneuvered over the respective rotation shaft 52 and onto roller half 30b on the holder tool 54, 565 to form a partially assembled configuration of the new roller 26. The partially assembly configuration is supported on the holder tool 54, 56 during the inserting of the elongate fastener elements 32, 34 into the roller halves 30a, 30b parallel to the respective rotation shaft 52.

In traveling band screen 10, maintenance and repair operations are facilitated and downtime is reduced, thereby reducing costs and enabling more continuity in production. Damaged rollers 24 or 26 may be removed and new rollers 26 installed without removing chains 14, 16.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A traveling band screen comprising: a support frame assembly; two continuous chains movably mounted to said support frame assembly for motion along respective mutually parallel endless paths; a plurality of mesh members each secured on opposing edges to said chains; and a plurality of rollers rotatably mounted to each of said chains, one or more of said rollers being split rollers each having a respective rotation axis extending perpendicularly to the respective one of said chains, each said split roller having two roller halves secured to one another via elongate fasteners extending parallel to the respective roller rotation axis.

2. The traveling band screen defined in claim 1 wherein each of said roller halves includes a main body in the form of an annular section and further includes two tongues or flanges, one of said tongues or flanges being formed on one end of said annular section and the other of said tongues or flanges being formed on an opposite end of said annular section, the tongues or flanges of one of said roller halves engaging respective ones of the tongues or flanges of the other of said roller halves so that the tongues or flanges on each side of the split roller overlap and are at least substantially coextensive with one another, said elongate fastener elements extending at least partially into said tongues or flanges.

3. The split roller defined in claim 2 wherein each of said tongues or flanges of one roller half has a face that is engageable a surface of a tongue or flange of the other roller half, said face having a first raised area and a first recessed area, said surface having a second raised area and a second recessed area, said first raised area extending into said second recessed area and said first recessed area receiving said second raised area.

4. The traveling band screen defined in claim 1 wherein each of said roller halves has a partially semi-annular body section of a predetermined thickness, said body section being formed at each of two opposite ends with a respective flange or tongue, each said flange or tongue of one of said roller halves of a given split roller overlapping and being coextensive with a flange or tongue of the other of said roller halves of said given split roller, one of said elongate fasteners at least partially traversing each of two overlapping ones of the flanges or tongues.

5. The traveling band screen defined in claim 4 wherein each of said flanges or tongues are of approximately half said predetermined thickness.

6. The traveling band screen defined in claim 4 wherein each said flange or tongue has a surface facing the corresponding overlapping flange or tongue, said surface being formed at a free end, opposite said body section, with a raised area.

7. A method for repairing a traveling band filter including a supporting frame assembly, a pair of continuous chains each carrying a plurality of rollers engaging said supporting frame assembly for enabling motion of said chains along respective mutually parallel endless paths, a multiplicity of mesh or sieve members each secured along opposing edges to respective ones of said chains, each of said rollers being turnably mounted on a rotation shaft in turn mounted to one of said chains, the method comprising: removing a selected one of said rollers; maintaining the respective chain in a continuous and operative configuration and maintaining the respective rotation shaft connected to said respective chain during the removing of said selected one of said rollers; subsequently mounting a new roller to said respective rotation shaft; maintaining said respective chain in a continuous and operative configuration and maintaining said respective rotation shaft connected to said respective chain during the mounting of said new roller, thereby replacing said selected one of said rollers without disassembling or disassociating any links of said respective chain and without removing said respective rotation shaft.

8. The method defined in claim 7 wherein said new roller is a split roller comprising a pair of roller halves, the mounting of said new roller to said respective rotation shaft including inserting said roller halves about said respective rotation shaft and fixing said roller halves to one another by inserting a pair of elongate fastener elements at least partially through said roller halves parallel to said respective rotation shaft.

9. The method defined in claim 8 wherein each of said roller halves includes a main body in the form of an annular section and further includes two tongues or flanges, one of said tongues or flanges being formed on one end of said annular section and the other of said tongues or flanges being formed on an opposite end of said annular section, the mounting of said new roller to said respective rotation shaft including placing the tongues or flanges of one of said roller halves into engagement with respective ones of the tongues or flanges of the other of said roller halves so that the tongues or flanges on each side of the assembled new roller overlap and are at least substantially coextensive with one another, the inserting of said elongate fastener elements at least partially through said roller halves including inserting said fastener elements into said tongues or flanges.

10. The method defined in claim 8 wherein each of said tongues or flanges of one roller half has a face that is engageable a surface of a tongue or flange of the other roller half, said face having a first raised area and a first recessed area, said surface having a second raised area and a second recessed area, the mounting of said new roller to said respective rotation shaft including inserting said first raised area into said second recessed area and inserting said second raised area into said first recessed area.

11. The method defined in claim 8 wherein the mounting of said new roller to said respective rotation shaft includes supporting one of said roller halves on a holder tool below said respective rotation shaft, maneuvering the other of said roller halves over said respective rotation shaft and onto said one of said roller halves on said holder tool to form a partially assembled configuration of said new roller, and supporting said partially assembly configuration on said holder tool during the inserting of said elongate fastener elements at least partially through said roller halves parallel to said respective rotation shaft.

12. A split roller for a traveling band filter including a supporting frame assembly, a pair of continuous chains each carrying a plurality of rollers engaging said supporting frame assembly for enabling motion of said chains along respective mutually parallel endless paths, a multiplicity of mesh or sieve members each secured along opposing edges to respective ones of said chains, each of said rollers being turnably mounted on a respective rotation shaft mounted to the respective one of said chains, said split roller for mounting to one of said chains as one of said rollers comprising a pair of roller halves and a pair of elongate fastener elements, said elongate fastener elements extending at least partially through said roller halves parallel to an axis of rotation of said split roller.

13. The split roller defined in claim 12 wherein each of said roller halves includes a main body in the form of an annular section and further includes two tongues or flanges, one of said tongues or flanges being formed on one end of said annular section and the other of said tongues or flanges being formed on an opposite end of said annular section, the tongues or flanges of one of said roller halves engaging respective ones of the tongues or flanges of the other of said roller halves so that the tongues or flanges on each side of the split roller overlap and are at least substantially coextensive with one another, said elongate fastener elements extending at least partially into said tongues or flanges.

14. The split roller defined in claim 13 wherein each of said tongues or flanges of one roller half has a face that is engageable with a surface of a tongue or flange of the other roller half, said face having a first raised area and a first recessed area, said surface having a second raised area and a second recessed area, said first raised area extending into said second recessed area and said first recessed area receiving said second raised area.
